(19) United States
(12) Patent Application Publication
(10) Pub. No.: US 2007/0051607 A1
(43) Pub. Date: Mar. 8, 2007

(54) PUSH-BUTTON SWITCH ASSEMBLY FOR A VEHICLE

(75) Inventors: Brian Scigiel, Southgate, MI (US); Bruce Pierik, Hazel Park, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: LEAR CORPORATION, Southfield, MI (US)

(21) Appl. No.: 11/161,940

(22) Filed: Aug. 23, 2005

(51) Int. Cl. H01H 13/14

(52) U.S. Cl. 200/341

(57) ABSTRACT

A push-button assembly for a vehicle includes a housing having at least one housing finger that is defined by a housing opening. A push-button is integrated with the housing finger wherein the housing finger has a push-button stem integrated therewith. Additionally, the push-button assembly may include a light pipe capture that is also integrated with the housing. Furthermore, the assembly may include a circuit board having switch that is disposed within the housing.

### BACKGROUND OF THE INVENTION

1. Field of the Invention

The present invention relates to a push-button switch assembly for a vehicle.

2. Background Art

Switch assemblies containing electrical components are used in many appliances, motor vehicles and the like. The typical switch assembly includes a housing, a printed circuit board having a switch, and a button plate. The printed circuit board is contained within the housing. Accordingly, the button plate is attached to the housing in a manner that aligns the buttons with the switch located within the housing. These conventional switch assemblies require the use of multiple manufacturing tools during the manufacturing process.

Particularly, referring to FIG. 1, a prior art switch assembly 6 is shown. Switch assembly 6 includes a circuit board 7, a housing 8, and a button plate 9. Housing 8 is formed through the use of a first manufacturing tool in accordance with predefined design parameters. Additionally, button plate 9 is formed through the use of a second manufacturing tool whose design must also comport with the predefined design parameters as well as the fit and finish of housing 8.

The requirement of multiple manufacturing tools during the manufacturing process is cumbersome and inefficient. For example, the manufacturer must operate and maintain multiple tools to form the housing and the button plate. Also, formation of the housing and the button plate must be coordinated for assembling the switch assembly. Additionally, assembling the switch assembly requires at least the additional step of attaching the housing to the button plate. Thus, the above considerations increase the assembly and material costs, the possible failure modes associated with the switch assembly, and complicates construction of the switch assembly.

The present invention was conceived in view of these and other disadvantages of conventional switch assemblies.

### SUMMARY OF THE INVENTION

The present invention provides a push-button assembly and method for a vehicle. The push-button assembly includes a housing having at least one housing finger that is defined by a housing opening. A push-button is integrated with the housing finger wherein the housing finger has a push-button stem integrated therewith. Additionally, the push-button assembly may include a light pipe capture that is also integrated with the housing. Furthermore, the assembly may include a circuit board having switch that is disposed within the housing.

A method of manufacturing the push-button assembly is included. The method includes forming the housing having the at least one housing finger and the push-button. The housing finger is defined by a housing opening and the push-button is located adjacent to the housing finger. The method also includes disposing a circuit board within the housing wherein the circuit board includes a switch attached thereto. The method may also include the housing being formed having an upper housing member and a lower housing member. Accordingly, the method may include forming a living hinge formed of a polycarbonate material that connects the upper housing member to the lower housing member.

The above embodiments and other embodiments, features, and advantages of the present invention are readily apparent from the following detailed description of the best mode for carrying out the invention and taken in connection with the accompanying drawings.

### BRIEF DESCRIPTION OF THE DRAWINGS

The features of the present invention which are believed to be novel are set forth with particularity in the appendant claims. The present invention, both as to its organization and manner of operation, together with further objects and advantages thereof, may be best understood with reference to the following description, taken in connection with the accompanied drawings in which:

FIG. 1 illustrates a prior art switch assembly;

FIG. 2 illustrates a perspective view of a push-button switch assembly in accordance with an embodiment of the present invention;

FIG. 3 illustrates an exploded view of the push-button switch assembly of FIG. 1; and

FIG. 4 illustrates a flow diagram of a method for manufacturing and installing a push-button switch assembly.

### DETAILED DESCRIPTION OF THE PREFERRED EMBODIMENT(S)

As required, detailed embodiments of the present invention are disclosed herein. However, it is to be understood that the disclosed embodiments are merely exemplary of the invention that may be embodied in various and alternative forms. The figures are not necessarily to scale, and some features may be exaggerated or minimized to show details of particular components. Therefore, specific functional details disclosed herein are not to be interpreted as limiting, but merely as a representative basis for the claims and/or as a representative basis for teaching one skilled in the art to variously employ in the present invention.

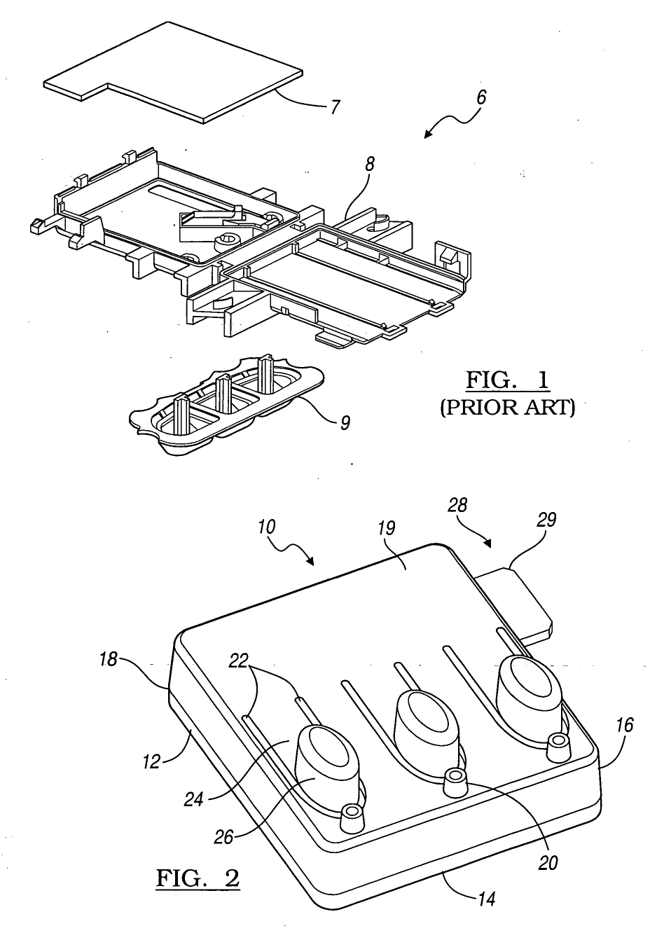

Now, referring to FIG. 2, a push-button switch assembly 10 is illustrated in accordance with an embodiment of the present invention. Push-button switch assembly 10 includes a housing 12 that contains a circuit board 28. Housing 12 may include an upper housing member 16 and a lower housing member 14. In one embodiment, upper housing member 16 may be formed of a polycarbonate material. Additionally, lower housing member 14 may be formed of a polypropylene material. It is recognized, however, that upper housing member 16 and lower housing member 14 may be formed of other materials without departing from the scope of the present invention. The upper and lower housing members 14 and 16 may be connected by a hinge portion 18. Hinge portion 18 may be a living hinge that is formed of a polypropylene material. It is also recognized, that in alternative embodiments hinge portion 18 may not be required. In such an embodiment, upper and lower housing members 14 and 16 may be snapped together through the use of clips that are integrated with upper and lower housing members 14 and 16.

Circuit board 28 includes a connector portion 29 that enables push-button switch assembly 10 to be coupled to a power source or adjacent systems within a vehicle. Additionally, housing 12 may include a light pipe capture 20 that provides a structure for containing a light tube.

A plurality of housing fingers 24 are defined by a housing opening 22. A push-button 26 is integrated with housing 12 via housing fingers 24. As such, housing finger 24 is formed so as to have a sufficient amount of flexibility to enable a user to press push-button 26, engage a switch coupled to circuit board 28 and return to the original un-pressed position. In one embodiment, push-button 26 is formed of a polycarbonate material.

Housing 12, which includes upper and lower housing members 14 and 16, housing fingers 24, and push-buttons 26, may be formed through the use of an injection molding process that utilizes a single injection molding tool. Such an injection molding tool is available from Great Lakes Mold, 50670 Rizzo Drive, Shelby Township, Mich. 48315. Alternatively, upper and lower housing members 14 and 16 may be formed through the use of a “2-shot” injection molding process utilizing the single injection molding tool. In such an embodiment, upper housing member 14 is formed of a polycarbonate material during a first shot. Accordingly, lower housing member 16 and hinge portion 18 may be simultaneously formed of a polypropylene material during a second shot. As such, the manufacturing process for housing 12 is improved over conventional manufacturing processes in that a single injection molding tool may be utilized and a separately manufactured button plate is not required.

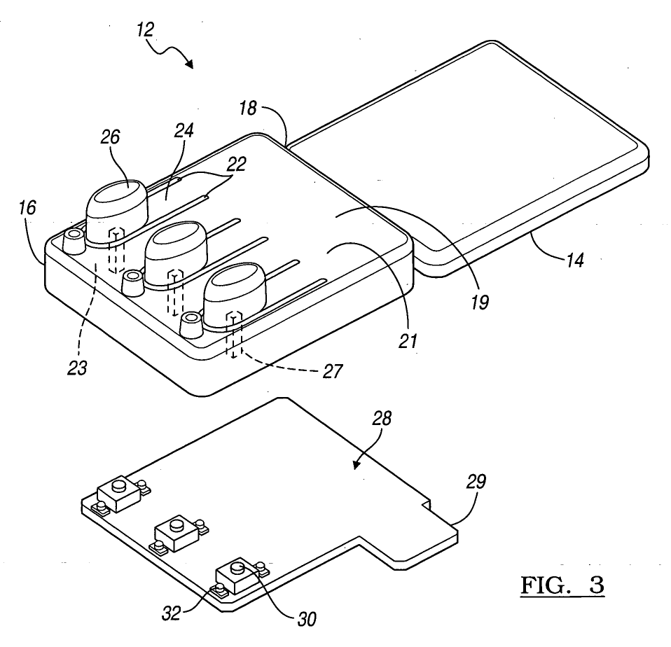

Now referring to FIG. 3, an exploded view of push-button switch assembly 10 is illustrated. As described above housing 12 includes upper housing member 16, which is coupled to lower housing member 14 via hinge portion 18. Housing opening 22 defines housing finger 24 that has push-button 26 integrated thereto. As shown in FIG. 3, a push-button stem 27 is also integrated with housing 12 via housing fingers 24. Accordingly, when the user presses push-button 26 push-button stem 27 contacts a switch 30 located on circuit board 28. Switch 30 further includes at least one mounting stud 32 that secures switch 30 to circuit board 28.

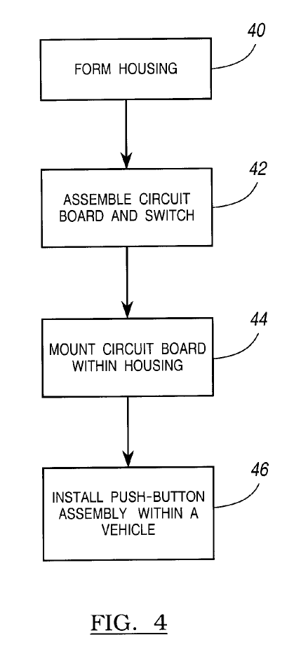

Now referring to FIG. 4 a flow diagram of a method for manufacturing push-button switch assembly 10 is shown. Accordingly, as depicted by block 40 a housing for the push-button switch assembly is formed. As described above, the housing may be formed of an upper housing member and the lower housing member. In one embodiment the upper housing member is formed of a polycarbonate material and the lower housing member is formed of a polypropylene material. The upper and lower housing members are connected by a hinge portion that may be formed of a polypropylene material. Additionally, the push-button, the housing fingers, and housing openings are formed through the use of the single injection molding machine. Furthermore, the light pipe capture and push-button stem may be injection molded concurrently with the forming of push-button 26 and housing fingers 24.

As depicted by block 42, the circuit board and switch are assembled having the required circuitry in accordance with design parameters. As depicted by block 44, the circuit board having the switch is mounted within the housing. As depicted by block 46, the push-button switch assembly may be installed within a vehicle. In one embodiment, the push-button switch assembly is installed within the interior of the vehicle, particularly the ceiling area of the vehicle.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A push-button switch assembly for a vehicle, comprising:
a housing having an upper housing member that includes an upper panel and at least one housing finger defined by a housing opening, wherein the housing finger is coplanar with the upper panel; and
a push-button integrated with the housing finger, wherein the housing finger has a push-button stem integrated therewith.

2. An assembly according to claim 1, further comprising a light pipe capture that is integrated with the housing.

3. An assembly according to claim 1, wherein the housing comprises the upper housing member and a lower housing member.

4. An assembly according to claim 3, wherein the upper and lower housing members are connected through the use of a hinge.

5. An assembly according to claim 4, wherein the hinge is a living hinge comprised of a polypropylene material.

6. An assembly according to claim 3, wherein the upper housing member is comprised of a polycarbonate material.

7. An assembly according to claim 3, wherein the lower housing member is comprised of a polypropylene material.

8. An assembly according to claim 3, further comprising a circuit board that is disposed between the upper housing member and the lower housing member.

9. An assembly according to claim 8, further comprising a switch that is coupled to the circuit board.

10. A method of manufacturing a push-button switch assembly for a vehicle, comprising:
forming a housing having an upper housing member that includes an upper panel and at least one housing finger and a push-button, wherein the housing finger is coplanar with the upper panel and is defined by a housing opening, and the push button is located adjacent to the housing finger; and
disposing a circuit board within the housing, wherein the circuit board includes a switch attached thereto.

11. A method according to claim 10, wherein forming a housing includes forming a housing comprising the upper housing member and a lower housing member.

12. A method according to claim 11, further comprising forming a living hinge that comprises a polypropylene material, wherein the living hinge connects the upper housing member to the lower housing member.

13. A method according to claim 12, wherein forming the living hinge further includes forming the living hinge and the lower housing member simultaneously.

14. A method according to claim 11, wherein forming a housing comprising an upper housing member and a lower housing member includes forming an upper housing member comprising a polycarbonate material and forming a lower housing member comprising a polypropylene material.

15. A method according to claim 10, wherein forming a housing includes forming a housing having a light pipe capture integrated therewith.

16. A method according to claim 10, wherein forming a housing having at least one housing finger and a push-button includes a push-button formed of a polycarbonate material.

17. A method according to claim 10, wherein forming the housing having at least one housing finger and a push-button includes forming the housing through the use of an injection molding process.

18. A method according to claim 10, further comprising, integrating a push-button stem with the housing finger.

19. A push-button switch assembly for a vehicle, comprising:
a housing having an upper housing member and a lower housing member connected through the use of a living hinge, the upper housing member having:
an upper panel including a first surface and a second surface disposed opposite the first surface, the upper panel having at least one housing finger defined by an opening that extends between the upper and lower surfaces, wherein the housing finger is coplanar with the upper panel; and
a push-button integrated with the housing finger, wherein the housing finger has a push-button stem integrated therewith.
